(19) United States
(12) Patent Application Publication
(10) Pub. No.: US 2014/0358641 A1
(43) Pub. Date: Dec. 4, 2014

(54) METHOD AND SYSTEM FOR VEHICLE LEASES PERMITTING MULTIPLE VEHICLE EXCHANGES

(71) Applicant: Robert Friedman, Laguna Hills, CA (US)

(72) Inventor: Robert Friedman, Laguna Hills, CA (US)

(21) Appl. No.: 13/908,036

(22) Filed: Jun. 3, 2013

(51) Int. Cl. G06Q 30/02

(52) U.S. Cl. CPC G06Q 30/0206
USPC 705/7.35

(57) ABSTRACT

A system and related method are disclosed for pricing a lease allowing multiple vehicle exchanges, using a computer or similar device. The method involves accepting lessee data including the lessee driving record, and desired lease terms, vehicles, and vehicle exchanges, and combining it with other data such as initial values of vehicles, depreciation over the term and mileage of the lease, and the history of interaction between the lessee and lessor. The calculated price is published via the system display. The method may be practiced by a server, mobile device, or payment processing machine belonging to the lessee or lessor.

### TECHNICAL FIELD

Embodiments disclosed herein relate generally to the planning and creation of vehicle lease agreements, and specifically to electronic systems for determining the price for a lease based upon multiple factors.

### BACKGROUND ART

Automobile leasing is an increasingly popular alternative to purchasing automobiles. Rather than bearing the full cost of ownership of a car, a person who leases a vehicle is essentially purchasing its depreciation over the period of the lease. Because of this, lessees can drive a good quality car for a year or two, and then walk away from it and lease another car without concerning themselves with long term maintenance and similar issues. This approach also enables the lessee to drive more cars over a given period of years than he or she would be likely to by purchasing a series of cars or trading them in. However, leases generally require the lessee to operate only one vehicle under the terms of a particular lease, because of the difficulties that pricing more than one vehicle in a given lease would create. As a result, automobile leases still have not realized their full potential as a more flexible alternative to traditional automobile ownership.

There is thus a need for a system and method that will permit more flexibility in the vehicle leasing business.

### SUMMARY OF THE EMBODIMENTS

Disclosed herein is a method for pricing vehicle leases permitting multiple vehicle exchanges. The method includes accepting, by at least one electronic device, user-input data concerning lease provisions desired by the lessee, including information describing the number of vehicle exchanges the lessee wishes to make, accepting, by the at least one electronic device, user-input data comprising lessee information, calculating, by the at least one electronic device, a lease price using the user-input data, and publishing, by the at least one electronic device, the lease price.

In a related embodiment, the user-input data concerning lease provisions includes the make and model of at least one vehicle. In another embodiment, the user-input data concerning lease provisions further comprises a length of a desired lease term. In yet another embodiment, the user-input data concerning lease provisions further comprises an amount of mileage to be driven during the lease. According to a further embodiment, the user-input data further comprises an amount of insurance coverage desired by the lessee. Under another embodiment still, the user-input data concerning lessee information comprises a lessee driving record.

According to an additional embodiment calculating the lease price further comprises maintaining, in memory accessible to the electronic device, data organizing vehicles into price tiers, and calculating the lease price using the price tiers. In a further embodiment, calculating the lease price comprises maintaining, in memory accessible to the electronic device, data concerning the seasonal desirability of each available vehicle, and calculating the lease price using that data concerning the seasonal desirability of each vehicle. Under still another embodiment, calculating the lease price further comprises calculating likely vehicle depreciation over the probable lease term and mileage and calculating the lease price using that likely vehicle depreciation.

In an additional embodiment, calculating the lease price further comprises maintaining, in memory accessible to the electronic device, data recording the history of transactions between the lessee and the lessor and calculating the lease price using that history. In a related embodiment, the data recording the history of transactions between the lessee and lessor includes mileage in excess of lease mileage limits. In a further related embodiment, the data recording the history of transactions between the lessee and lessor includes damage to lessor property. In an additional related embodiment, the data recording the history of transactions between the lessee and lessor includes damage to third-party property.

Another embodiment involves accepting user inputs containing a desired change to lease elements during the lease term, calculating an adjusted lease price based on the desired change, determining the difference between the adjusted lease price and the original lease price, and modifying the original lease price using the difference. An additional embodiment involves receiving, by the electronic device, updated information concerning the lessee, the conduct of the lessee, or the compliance of the lessee with the lease terms and modifying, by the electronic device, the lease price according to the updated information.

Also disclosed is a system for calculating a vehicle lease price, comprising at least one electronic device having a processor and a memory. The system also comprises a user interface component executing on the at least one electronic device, accepting user-input data comprising lessee information, information describing the vehicles to be leased, and information describing the number of the exchanges of automobiles desired by the lessee, and publishing a calculated lease price. The system further comprises a price calculation component executing on the at least one electronic device and calculating a lease price using the user-input data.

In a related embodiment, one of the electronic devices comprising the system is a mobile device. In another embodiment, one of the electronic devices comprising the system is a server, and further comprising at least one client device. The system in another embodiment still also comprises a payment processing machine used by a lessor.

Other aspects, embodiments and features of the system and method will become apparent from the following detailed description when considered in conjunction with the accompanying figures. The accompanying figures are for schematic purposes and are not intended to be drawn to scale. In the figures, each identical or substantially similar component that is illustrated in various figures is represented by a single numeral or notation. For purposes of clarity, not every component is labeled in every figure. Nor is every component of each embodiment of the system and method shown where illustration is not necessary to allow those of ordinary skill in the art to understand the system and method.

### BRIEF DESCRIPTION OF THE DRAWINGS

The preceding summary, as well as the following detailed description of the disclosed system and method, will be better understood when read in conjunction with the attached drawings. For the purpose of illustrating the system and method, presently preferred embodiments are shown in the drawings. It should be understood, however, that neither the system nor the method is limited to the precise arrangements and instrumentalities shown.

FIG. 1 is a flow chart illustrating some embodiments of the disclosed method.

FIG. 2 is a schematic diagram depicting an example of an electronic device as described herein.

FIG. 3 is a schematic diagram of a web application platform, as disclosed herein.

FIG. 4 is a block diagram depicting one embodiment of the disclosed system.

### DETAILED DESCRIPTION OF SPECIFIC EMBODIMENTS

Definitions. As used in this description and the accompanying claims, the following terms shall have the meanings indicated, unless the context otherwise requires.

An “electronic device” is defined as including personal computers, laptops, tablets, smart phones, and any other electronic device capable of supporting an application as described herein.

A device or component is “coupled” to an electronic device if it is so related to that device that the product or means and the device may be operated together as one machine. In particular, a piece of electronic equipment is coupled to an electronic device if it is incorporated in the electronic device (e.g. a built-in camera on a smart phone), attached to the device by wires capable of propagating signals between the equipment and the device (e.g. a mouse connected to a personal computer by means of a wire plugged into one of the computer's ports), tethered to the device by wireless technology that replaces the ability of wires to propagate signals (e.g. a wireless BLUETOOTH® headset for a mobile phone), or related to the electronic device by shared membership in some network consisting of wireless and wired connections between multiple machines (e.g. a printer in an office that prints documents to computers belonging to that office, no matter where they are, so long as they and the printer can connect to the internet).

“Data entry means” is a general term for all equipment coupled to an electronic device that may be used to enter data into that device. This definition includes, without limitation, keyboards, computer mouses, touchscreens, digital cameras, digital video cameras, wireless antennas, Global Positioning System devices, audio input and output devices, gyroscopic orientation sensors, proximity sensors, compasses, scanners, specialized reading devices such as fingerprint or retinal scanners, and any hardware device capable of sensing electromagnetic radiation, electromagnetic fields, gravitational force, electromagnetic force, temperature, vibration, or pressure.

An electronic device's “display means” is a device coupled to the electronic device, by means of which the electronic device can display images. Display means include without limitation monitors, screens, television devices, and projectors.

To “maintain” data in the memory of an electronic device means to store that data in that memory in a form convenient for retrieval as required by the algorithm at issue, and to retrieve, update, or delete the data as needed.

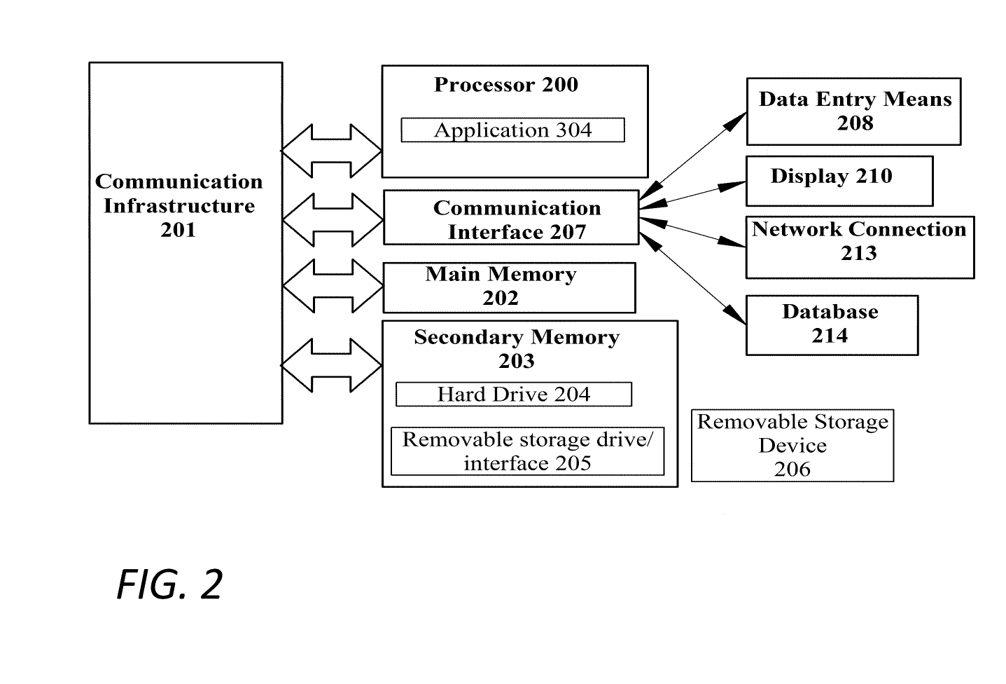

The system and method disclosed herein will be better understood in light of the following observations concerning the electronic devices that support the disclosed application, and concerning the nature of web applications in general. An exemplary electronic device is illustrated by FIG. 2. The processor 200 may be a special purpose or a general-purpose processor device. As will be appreciated by persons skilled in the relevant art, the processor device 200 may also be a single processor in a multi-core/multiprocessor system, such system operating alone, or in a cluster of computing devices operating in a cluster or server farm. The processor 200 is connected to a communication infrastructure 201, for example, a bus, message queue, network, or multi-core message-passing scheme.

The electronic device also includes a main memory 202, such as random access memory (RAM), and may also include a secondary memory 203. Secondary memory 203 may include, for example, a hard disk drive 204, a removable storage drive or interface 205, connected to a removable storage unit 206, or other similar means. As will be appreciated by persons skilled in the relevant art, a removable storage unit 206 includes a computer usable storage medium having stored therein computer software and/or data. Examples of additional means creating secondary memory 203 may include a program cartridge and cartridge interface (such as that found in video game devices), a removable memory chip (such as an EPROM, or PROM) and associated socket, and other removable storage units 206 and interfaces 205 which allow software and data to be transferred from the removable storage unit 206 to the computer system.

The electronic device may also include a communications interface 207. The communications interface 207 allows software and data to be transferred between the electronic device and external devices. The communications interface 207 may include a modem, a network interface (such as an Ethernet card), a communications port, a PCMCIA slot and card, or other means to couple the electronic device to external devices. Software and data transferred via the communications interface 207 may be in the form of signals, which may be electronic, electromagnetic, optical, or other signals capable of being received by the communications interface 207. These signals may be provided to the communications interface 207 via wire or cable, fiber optics, a phone line, a cellular phone link, and radio frequency link or other communications channels. The communications interface in the system embodiments discussed herein facilitates the coupling of the electronic device with data entry devices 208, the device's display 210, and network connections, whether wired or wireless 213. It should be noted that each of these means may be embedded in the device itself, attached via a port, or tethered using a wireless technology such as BLUETOOTH®.

Computer programs (also called computer control logic) are stored in main memory 202 and/or secondary memory 203. Computer programs may also be received via the communications interface 207. Such computer programs, when executed, enable the processor device 200 to implement the system embodiments discussed below. Accordingly, such computer programs represent controllers of the system. Where embodiments are implemented using software, the software may be stored in a computer program product and loaded into the electronic device using a removable storage drive or interface 205, a hard disk drive 204, or a communications interface 207.

Persons skilled in the relevant art will also be aware that while any device must necessarily comprise facilities to perform the functions of a processor 200, a communication infrastructure 201, at least a main memory 202, and usually a communications interface 207, not all devices will necessarily house these facilities separately. For instance, in some forms of electronic devices as defined above, processing 200 and memory 202 could be distributed through the same hardware device, as in a neural net, and thus the communications infrastructure 201 could be a property of the configuration of that particular hardware device. Many devices do practice a physical division of tasks as set forth above, however, and practitioners skilled in the art will understand the conceptual separation of tasks as applicable even where physical components are merged.

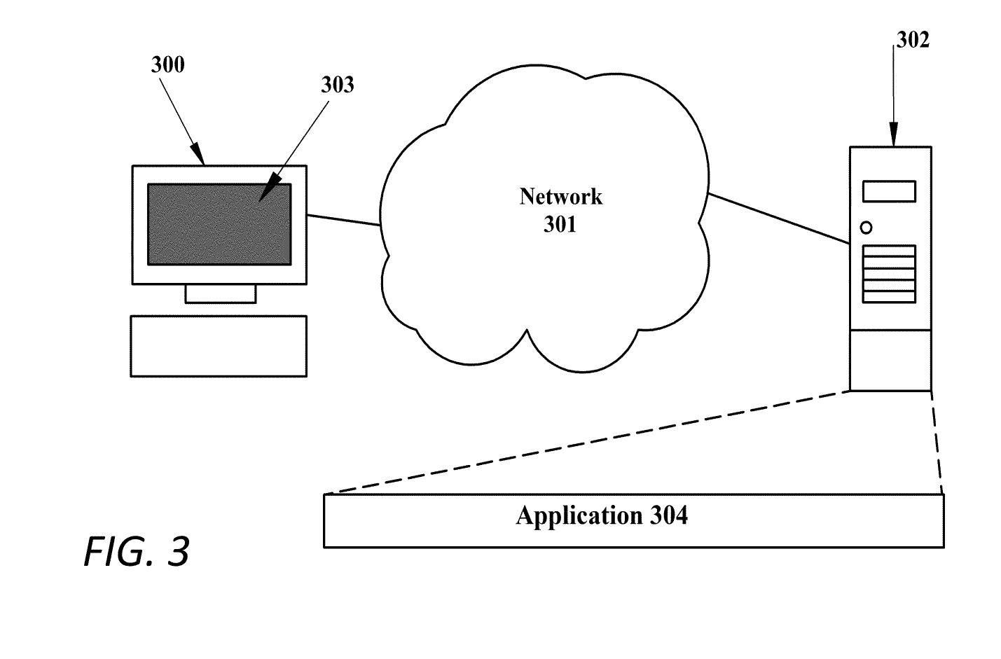

The systems may be deployed in a number of ways, including on a stand-alone electronic device, a set of electronic devices working together in a network, or a web application. Persons of ordinary skill in the art will recognize a web application as a particular kind of computer program system designed to function across a network, such as the Internet. A schematic illustration of a web application platform is provided in FIG. 3. Web application platforms typically include at least one client device 300, which is an electronic device as described above. The client device 300 connects via some form of network connection to a network 301, such as the Internet. The network 301 may be any arrangement that links together electronic devices 300, 302, and includes without limitation local and international wired networks including telephone, cable, and fiber-optic networks, wireless networks that exchange information using signals of electromagnetic radiation, including cellular communication and data networks, and any combination of those wired and wireless networks. Also connected to the network 301 is at least one server device 302, which is also an electronic device as described above. Of course, practitioners of ordinary skill in the relevant art will recognize that a web application can, and typically does, run on several server devices 302 and a vast and continuously changing population of client devices 300. Computer programs on both the client device 300 and the server device 302 configure both devices to perform the functions required of the web application 304. Web applications 304 can be designed so that the bulk of their processing tasks are accomplished by the server device 302, as configured to perform those tasks by its web application program, or alternatively by the client device 300. However, the web application must inherently involve some programming on each device.

Many electronic devices, as defined herein, come equipped with a specialized program, known as a web browser, which enables them to act as a client device 300 at least for the purposes of receiving and displaying data output by the server device 302 without any additional programming. Web browsers can also act as a platform to run so much of a web application as is being performed by the client device 300, and it is a common practice to write the portion of a web application calculated to run on the client device 300 to be operated entirely by a web browser. Such browser-executed programs are referred to herein as “client-side programs,” and frequently are loaded onto the browser from the server 302 at the same time as the other content the server 302 sends to the browser. However, it is also possible to write programs that do not run on web browsers but still cause an electronic device to operate as a web application client 300. Thus, as a general matter, web applications 304 require some computer program configuration of both the client device (or devices) 300 and the server device 302 (or devices). The computer program that comprises the web application component on either electronic device's system FIG. 2 configures that device's processor 200 to perform the portion of the overall web application's functions that the programmer chooses to assign to that device. Persons of ordinary skill in the art will appreciate that the programming tasks assigned to one device may overlap with those assigned to another, in the interests of robustness, flexibility, or performance. Finally, although the best known example of a web application as used herein uses the kind of hypertext markup language protocol popularized by the World Wide Web, practitioners of ordinary skill in the art will be aware of other network communication protocols, such as File Transfer Protocol, that also support web applications as defined herein.

The disclosed system and method allows the flexibility of an auto lease to reach its full potential. No longer tied to a single car by ownership or lease contracts, lessees can come closer than ever before to driving the perfect car. A lessee can drive a convertible in the summer, a heavier all-wheel drive vehicle in the winter, and a hybrid for a lengthy road trip. Pricing options ranging from luxurious new models to previously owned economy models ensure that a car exists to fill the needs of every driver. The lessor in turn can use the finely tuned calculations of the disclosed method to control costs and manage risk while rewarding good customers.

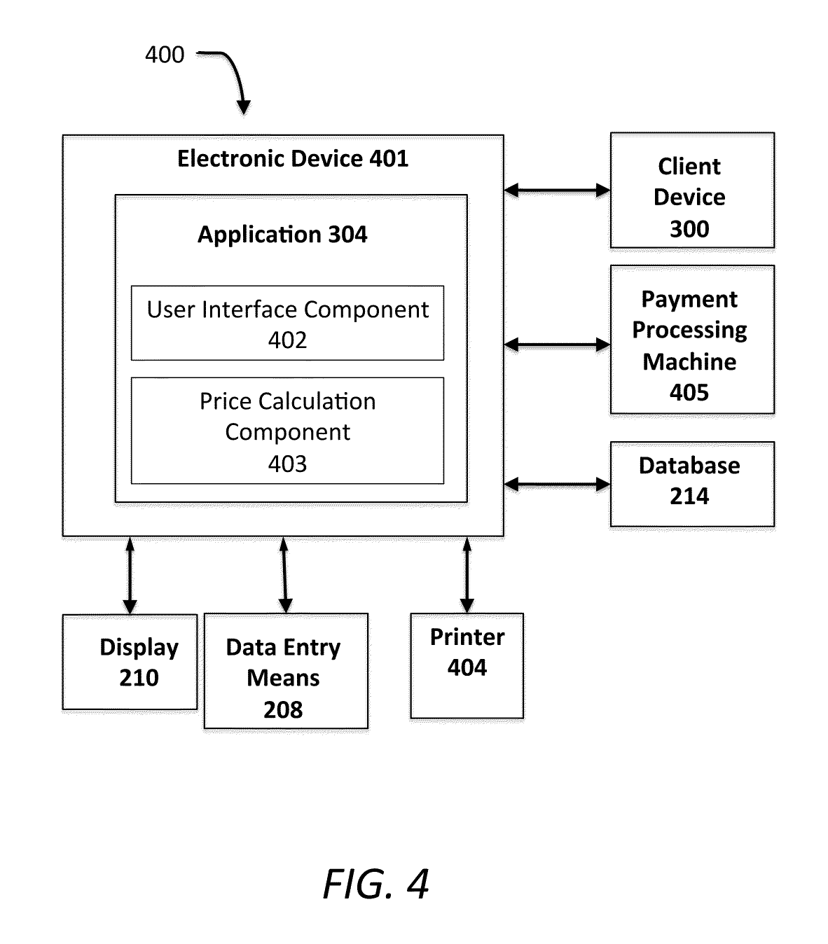

FIG. 4 illustrates some embodiments of the disclosed system 400. The first element is at least one electronic device 401, which is an electronic device as disclosed above in reference to FIGS. 2 and 3. The electronic device is programmed or configured to perform the tasks of an application 304. The application 304 may be composed of one or more a computer programs as described above in reference to FIGS. 2 and 3. The tasks the application 304 performs may be conceptually divided into a user interface component 402 and a price calculation component 403. The organization of tasks into those two components solely reflects a categorization of the tasks to be performed, and does not dictate the architecture of particular implementations of the system 400.

Turning now to FIG. 4 in more detail, and referring to FIGS. 2 and 3, the first element of the disclosed system is at least one electronic device 401. The device or devices may be any electronic device as described above in reference to FIGS. 2 and 3. In some embodiments, one of the electronic devices 401 comprising the system 400 is a mobile device, such as a smartphone or tablet. The system 400 may consist entirely of a mobile device 401 executing the application 304 as a mobile app. In some embodiments, one of the electronic devices 401 comprising the system 400 is a server 302, and the system further comprises at least one client device 300, as disclosed above in reference to FIG. 3. In some embodiments, the system 400 includes a payment processing machine 405 used by the lessor. A payment processing machine 405 is a machine that registers the exchange of goods and services for money, and by means of which the vendor acknowledges that exchange and authorizes the customer to accept the goods and services. The payment processing machine 405 may be used by the lessor to process the initial lease agreement and any down payment, or it may register the regular lease payments by the lessee. In some embodiments, the payment processing machine 405 may be a cash register or similar station operated by an employee in a location possessed by or used by the lessor. In some embodiments, the payment processing machine is a server 302 operated by or on behalf of the lessor. In some embodiments, the payment processing machine 405 is the electronic device 401 running the application 304.

The system 400 also includes an application, 304. The application 304 may be composed of computer programs as disclosed above in reference to FIG. 2. As previously noted, these programs may be software programs stored in primary 202 or secondary memory 203, and which direct the electronic device or devices 401 to execute the tasks that make up the application. Alternatively, the programs may partially or wholly consist of hardware circuitry that accomplishes the same configuration. The application 304 performs tasks that include those of a user interface component 402. The user interface component 402 communicates with data entry means 208 accessible to the electronic device or devices 401, including the screen or keyboard of a mobile device, computer, or payment processing machine, among other possibilities. If the electronic device 401 performing most of the application's tasks is a server 302, the user interface component 402 may consist of bother server-side and client-side programs that accept the user input data at a client machine 300, pass it over the network 301 connecting the client machine to the server 302, and accept the data at the server 302 for use by the application 304. The user interface component 402 likewise may coordinate the passage of data between any two electronic devices 401 making up the system, or between an electronic device 401 and a payment processing machine 405. The user interface component 402 may also display data for a lessee or lessor to view. In particular, the user interface component 402 publishes the price that the application 304 calculates. The user interface component 402 may display the price on the display 210 of one of the electronic devices 401, or it may transmit it to a printer 404 available to the system 400. The printer 404 may print the price out as part of a lease contract, and the display 210 may display the price as part of the lease contract as well.

The system 400 also includes a set of tasks performed by the application 304 that comprise a price calculation component 403. The price calculation component uses the information collected by the user interface component 402 to calculate a lease price, according to factors set forth in more detail below. In addition to the user-input data, the price calculation component 403 may use data stored in memory accessible to the electronic device 401. An example of such data is data recording the sale price of a particular make or model of car, to assess the initial value of such a car. Another example is data that aids in calculating the depreciation of a car that occurs over a certain period of time and with a certain mileage. Another kind of data that the price calculation component 403 may use is data concerning the past relationship between the lessee and the lessor; for example, whether the lessee has complied with mileage limits or damaged a leased vehicle in the past. In addition to the memory of the device, 401, some of this data may be maintained in a database 212 accessible to the device 401. A database 212 is any structured collection of data. As used herein, databases can include “NoSQL” data stores, which store data in a few key-value structures such as arrays for rapid retrieval using a known set of keys (e.g. array indices). Another possibility is a relational database, which can divide the data stored into fields representing useful categories of data. As a result, a stored data record can be quickly retrieved using any known portion of the data that has been stored in that record by searching within that known datum's category within the database 212, and can be accessed by more complex queries, using languages such as Structured Query Language, which retrieve data based on limiting values passed as parameters and relationships between the data being retrieved. A database can be created in any digital memory. The data that was not input via the user input component 402 but which the price calculation component 403 needs for its calculation may also be obtained by communicating with another electronic device outside the system 400 via the network 301. Thus, for instance, the price calculation component 403 may incorporate the driving record of the lessee in its calculation, and obtain that record by querying a server maintained by an organization that keeps track of driving records.

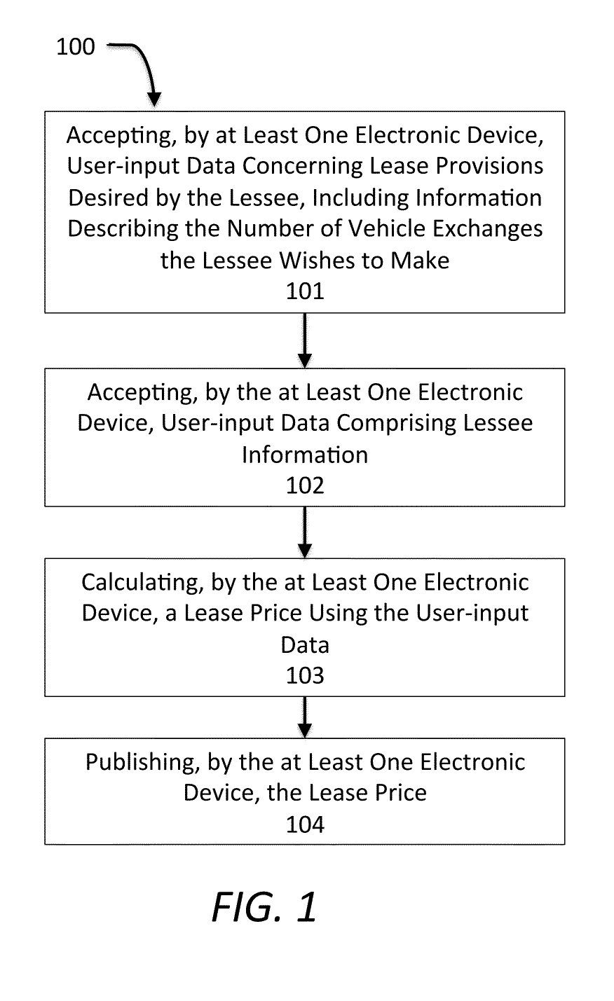

FIG. 1 illustrates some embodiments of the disclosed method 100. The method 100 includes accepting, by at least one electronic device, user-input data concerning lease provisions desired by the lessee, including information describing the number of vehicle exchanges the lessee wishes to make (101). In addition, the method 100 includes accepting, by the at least one electronic device, user-input data comprising lessee information (102). The method 100 also includes calculating, by the at least one electronic device, a lease price using the user-input data (103). The method 100 includes publishing, by the at least one electronic device, the lease price (104) as well.

Examining FIG. 1 in more detail, and by reference to FIG. 4, the method includes accepting, by at least one electronic device, user-input data concerning lease provisions desired by the lessee, including information describing the number of vehicle exchanges the lessee wishes to make (103). The method 100 may permit a lessee to exchange one vehicle for another as many times as desired during the term of the lease. While this increases the flexibility of the lease for the lessee and makes it more desirable by increasing the options available to the lessee, it also creates additional costs to the lessor. Such costs may include the processing necessary to accept vehicles used by the lessee and prepare them for presentation to another lessee, and the risk of damage and depreciation to a wider range of vehicles. Thus, some embodiments require the lessee inform the system in advance of the number of exchanges to be made. In some embodiments, the user-input data concerning lease provisions includes the make and model of at least one vehicle. Persons skilled in the relevant art will recognize that in the context of vehicle sales and manufacturing, “make” signifies the manufacturer (e.g. FORD®), while “model” signifies the particular type of vehicle the manufacturer provided (e.g. ESCORT®). This information also naturally affects the pricing of the lease, as a more expensive vehicle should be leased at a higher price, as set forth in more detail below. The user interface component 402 may allow the lessee to enter this information as text, or it may offer a menu of available vehicles. In some embodiments, the lessee will also be able to request new vehicles, or to request used vehicles of varying degrees of wear.

In some embodiments, the user-input data concerning lease provisions further comprises a length of a desired lease term. As before, the user interface component 402 may offer a menu of possibilities that the lessor is prepared to accept. In some embodiments, the user-input data concerning lease provisions further comprises an amount of mileage to be driven during the lease. This may be a number describing the total mileage to be used throughout the entire lease, but the user interface component 402 may also request that the lessee input the number of miles that will be driven with each vehicle. The latter, vehicle-specific approach may be especially useful when the lessee also has submitted the make and model of each vehicle the lessee intends to use during the course of the lease, as it will aid in the depreciation calculation described in detail below.

In some embodiments, the lessor provides insurance to the lessee for the duration of the lease, either by directly insuring the vehicles and charging the lessee a premium, or by purchasing the insurance from a third-party insurance company and charging the resulting premium to the lessee as part of the lease price. Accordingly, in some embodiments of the method 100 the user-input data further comprises an amount of insurance coverage desired by the lessee. In some embodiments, the user interface component 402 provides the lessee with options such as liability insurance, protecting against damage and injury to property other than the leased vehicles and persons other than the lessee, as well as insurance covering the cost of repairing damages to the leased vehicles. Some embodiments also permit the lessee to choose the amount of each category of coverage, subject to any minimum limits that locally applicable laws or the financial requirements of the lessor might impose.

The method 100 also includes accepting, by the at least one electronic device, user-input data comprising lessee information (102). Lessee information may include information necessary to identify the lessee, such as the lessee's name, date of birth, and social security number. Lessee information may also include details about the lessee that demonstrate the degree of risk attendant to leasing a vehicle to the lessee. For instance in some embodiments, the user-input data concerning lessee information comprises a lessee driving record, which is the history of incidents involving the lessee that suggest the lessee would cost the insurer or the possessor of a leased car money. For example, if the lessee has been at fault in a large number of automobile collisions, the lessee is perhaps more likely to be involved in automobile collisions in the future; if the lessor is providing the insurance for the vehicle to be leased, a collision in which the lessee is at fault will require the lessor to pay for repairs, increasing the lessor's expenses with regard to the lessee. The lessee's criminal record, at least insofar as it pertains to negligent or reckless driving, may be relevant for similar reasons. Another kind of lessee information that the system 400 may request to aid in price calculation is the lessee's credit history or credit score. Each of these is a measure for how likely the lessee is to pay obligations the lessee has incurred. A reduced probability that the lessee will pay in a timely manner makes the lessee potentially more expensive to the lessor.

The method 100 includes calculating, by the at least one electronic device, a lease price using the user-input data (103). In some embodiments the price calculation component derives a price based upon the number of exchanges of vehicles the lessee has entered. In some embodiments, the price calculation component 403 derives a price based upon the make and model of the vehicle or vehicles that the lessee has requested. In further embodiments, the price calculation component 403 calculates the price using the length of the lease term that that was input into the system 400. In other embodiments, calculating the lease price further comprises maintaining, in memory accessible to the electronic device, data organizing vehicles into price tiers, and calculating the lease price using that data concerning the seasonable desirability of each vehicle. Price tiers are groupings of vehicles that all will command the same price, all other lease terms being equal. Factors that may guide the inclusion of a vehicle in a given tier include the initial value of the vehicle when new, whether the vehicle is new, and the degree of wear on the vehicle if it is not new. The tiers may be arranged from the top tier, containing new luxury vehicles, to a bottom tier, containing previously owned economy cars. Intermediate tiers may consist of previously owned luxury cars, new economy cars, and new or previously owned cars of intermediate value, such as pickup trucks. The price calculation component 403 may compute the price of a car using price tiers by matching the facts about the car to a tier, and then assigning the price associated with that tier to that car. In some embodiments, the price calculation component 403 finds a price tier based upon a requested price, and returns the vehicles in that tier for publication along with that price.

In some embodiments, the price calculation component 403 calculates the lease price by maintaining, in memory accessible to the electronic device, data concerning the seasonal desirability of each available vehicle and calculating the lease price using that data concerning the seasonal desirability of each vehicle. A vehicle's seasonal desirability is a measure of how much more demand there is likely to be for the vehicle at a particular time of year. For example, in climates with a summer and a winter, convertibles are likely to be more popular in the summer, when driving with the top down is pleasant, than in the winter. Likewise, during a season in which it typically snows, a car that has all-wheel drive or other facilities to improve handling in slippery conditions may be in higher demand. The data the electronic device 401 maintains in its memory concerning seasonal desirability may include sales statistics arranged by category or make and model of vehicle. The data may also include statistics kept by the lessor concerning past leases. The price calculation component 403 may calculate a higher price for a vehicle with higher seasonal desirability, i.e. for a vehicle that is in higher demand during the time of year in which the lessee wishes to lease that vehicle.

The price calculation component 403 in some embodiments calculates the lease price by calculating likely vehicle depreciation over the probable lease term and mileage, and calculating the lease price using that likely vehicle depreciation. The depreciation of a vehicle is a measure of the decrease in its market value based upon ordinary usage over a period of time and over a certain amount of mileage. The price calculation component 403 may perform this calculation in some embodiments by accessing a table of values for cars of various makes and models at various stages of mileage and years of age. The existence of such collections of data concerning depreciation are well-known to persons of ordinary skill in the art. The price calculation component 403 may also apply a formula to calculate the degree of depreciation in a typical car. The depreciation of a vehicle may also be a factor in determining the price based on the number of vehicle exchanges made during the lease term. For instance, where the lessee exchanges his or her vehicle for new vehicles several times during a lease term, the large amount of depreciation attendant to driving each new vehicle may result in a higher lease price.

In further embodiments, the price calculation component 403 calculates the lease price by maintaining, in memory accessible to the electronic device, data recording the history of transactions between the lessee and the lessor, and calculating the lease price using that history. This calculation may augment the price to cover the cost of unexpected expenses due to lessee behavior in the past, such as a collision, or damage to the vehicle caused by failure to maintain it properly. The calculation may also protect against the likely cost of similar occurrences in the future, based on the projected probability that the lessee will cause such expenses in the future. In some embodiments, the data recording the history of transactions between the lessee and lessor includes mileage in excess of lease mileage limits, which may affect, among other things, the depreciation calculation. In other embodiments, the data recording the history of transactions between the lessee and lessor includes damage to lessor property such as that caused by collisions or failure to maintain the vehicle adequately. In some embodiments, the damage to the property affects the price only to the extent that it is attributable to the lessee. In further embodiments, data recording the history of transactions between the lessee and lessor includes damage to third-party property.

In some embodiments, the price calculation component 403 calculates the lease price using the lessee information. In some embodiments the price calculation component 403 uses the driving record of the lessee to calculate the lease price. Where the driving record of the lessee includes damage to vehicles operated by the lessee, the price calculation component 403 may augment the lease price to offset the greater risk of future damage to lessor vehicles leased by the lessee during the lease. Where the driving record of the lessee includes damage to property other than the vehicle operated by the lessee, the price calculation component 403 may augment the lease price to offset a higher risk of liability to third parties resulting from damage inflicted by the lessee while operating the vehicle. Some embodiments of the price calculation component 403 will modify the price only in response to property damage involving the lessee where the lessee was at fault. In some embodiments, elements of the lessee's driving record that suggest the lessee is better than average at avoiding costs such as property damage will result in the price calculation component 403 reducing the lease price. The price calculation component 403 also uses the lessee's credit history to calculate the lease price in some embodiments.

The method 100 in some embodiments involves allowing the lessee to modify the lease contract. The electronic device 401 accomplishes this by accepting user inputs containing a desired change to lease elements during the lease term, calculating an adjusted lease price based on the desired change, determining the difference between the adjusted lease price and the original lease price, and modifying the original lease price using the difference. For instance, if the lessee unexpectedly needs more passenger or cargo space in his or her vehicle the user interface component 402 may accommodate that need by permitting the lessee to add to the lease a new vehicle exchange and information concerning the additional vehicle desired, whereupon the price calculation component 403 calculates an updated lease price taking into account the factors discussed below, as modified by the lessee's desired changes. The recalculation may be necessary to offset the costs to the lessor attendant to increasing the overall number of exchanges, any upgrade in vehicle cost regarding the newly requested vehicle, and the cost of unexpected change, which may require the lessor to expend additional funds to comply with the lessee's request. On the other hand, the lessee might achieve a reduction in price, for example by reducing the number of exchanges, and opting for a more economical model of vehicle, in response to reduced funds or other financial problems.

In some embodiments of the method 100, the price calculation component 403 modifies the lease price during the lease term in response to certain activity by the lessor. This may involve receiving, by the electronic device, updated information concerning the lessee, the conduct of the lessee, or the compliance of the lessee with the lease terms, and modifying, by the electronic device, the lease price according to the updated information. Information concerning the lessee that result in price modification may include new revelations concerning the lessee's driving record. Information about the lessee that affects the price may also include new revelations regarding the lessee's credit history. In other embodiments, lessee information affecting the price includes information about the lessee's criminal record. In some embodiments, data concerning the lessee's conduct that affects the price includes information describing damage to the leased vehicle resulting from the lessee's actions. In other embodiments, lessee conduct data includes damage to third-party property resulting from the lessee's actions. In some embodiments information concerning lessee compliance with lease terms that results in a price modification includes data indicating that the lessee has exceeded the mileage limit imposed by the lease. Information concerning lessee compliance with lease terms that results in a price modification may also include data indicating a failure by the lessee to maintain the vehicle as required by the lease.

Some embodiments of the method 100 include publishing, by the at least one electronic device, the lease price 104. “Publishing” in this context means making available to either the lessor or the lessee or both in such a way that the lessee and lessor can use the calculated price to execute the lease contract. Publishing may involve displaying the calculated lease price on the display of the lessee's mobile device. In some embodiments, publishing involves showing the lease price on the display of a payment processing device used by the lessor. Publishing may also involve transmitting the calculated price from the electronic device that performed the calculation to another device such as the lessor's payment processing device. In some embodiments, the electronic device 401 prints out the lease price using a printer available to the electronic device.

It will be understood that the system and method may be embodied in other specific forms without departing from the spirit or central characteristics thereof. The present examples and embodiments, therefore, are to be considered in all respects as illustrative and not restrictive, and the system method is not to be limited to the details given herein.

1. A method for calculating a vehicle lease price, comprising:
accepting, by at least one electronic device, user-input data concerning lease provisions desired by a lessee, including information describing the number of vehicle exchanges the lessee wishes to make;
accepting, by the at least one electronic device, user-input data comprising lessee information;
calculating, by the at least one electronic device, a lease price using the user-input data; and
publishing, by the at least one electronic device, the lease price.

2. A method according to claim 1, wherein the user-input data concerning lease provisions includes the make and model of at least one vehicle.

3. A method according to claim 1, wherein the user-input data concerning lease provisions further comprises a length of a desired lease term.

4. A method according to claim 1, wherein the user-input data concerning lease provisions further comprises an amount of mileage to be driven during the lease.

5. A method according to claim 1, wherein the user-input data concerning lease provisions further comprises an amount of insurance coverage desired by the lessee.

6. A method according to claim 1, wherein the user-input data concerning lessee information comprises a lessee driving record.

7. A method according to claim 1, wherein calculating the lease price further comprises:
maintaining, in memory accessible to the electronic device, data organizing vehicles into price tiers; and
calculating the lease price using the price tiers.

8. A method according to claim 1, wherein calculating the lease price comprises:
maintaining, in memory accessible to the electronic device, data concerning the seasonal desirability of each available vehicle; and
calculating the lease price using that data concerning the seasonal desirability of each vehicle.

9. A method according to claim 1, wherein calculating the lease price further comprises:
calculating likely vehicle depreciation over the probable lease term and mileage; and
calculating the lease price using that likely vehicle depreciation.

10. A method according to claim 1, wherein calculating the lease price further comprises:
maintaining, in memory accessible to the electronic device, data recording the history of transactions between the lessee and the lessor; and
calculating the lease price using that history.

11. A method according to claim 10, wherein the data recording the history of transactions between the lessee and lessor includes mileage in excess of lease mileage limits.

12. A method according to claim 10, wherein the data recording the history of transactions between the lessee and lessor includes damage to lessor property.

13. A method according to claim 10, wherein the data recording the history of transactions between the lessee and lessor includes damage to third-party property.

14. A method according to claim 1, further comprising:
accepting user inputs containing a desired change to lease elements during the lease term;
calculating an adjusted lease price based on the desired change;
determining the difference between the adjusted lease price and the original lease price; and
modifying the original lease price using the difference.

15. A method according to claim 1, further comprising:
receiving, by the electronic device, updated information concerning the lessee, the conduct of the lessee, or the compliance of the lessee with the lease terms; and
modifying, by the electronic device, the lease price according to the updated information.

16. A system for calculating a vehicle lease price, comprising:
at least one electronic device having a processor and a memory;
a user interface component executing on the at least one electronic device, accepting user-input data information describing the vehicles to be leased, information describing the number of the exchanges of automobiles desired by the lessee, and publishing a calculated lease price, and comprising lessee information; and
a price calculation component executing on the at least one electronic device and calculating a lease price using the user-input data.

17. A system according to claim 16 wherein one of the electronic devices comprising the system is a mobile device.

18. A system according to claim 16 wherein one of the electronic devices comprising the system is a server, and further comprising at least one client device.

19. A system according to claim 16, further comprising a payment processing machine used by a lessor.
